(19) United States
(12) Patent Application Publication
(10) Pub. No.: US 2021/0103820 A1
(43) Pub. Date: Apr. 8, 2021

(54) PIPELINED BACKPROPAGATION WITH MINIBATCH EMULATION

(71) Applicant: Vathys, Inc., Portland, OR (US)

(72) Inventor: Tapabrata Ghosh, Portland, OR (US)

(21) Appl. No.: 16/592,645

(22) Filed: Oct. 3, 2019

(51) Int. Cl. G06N 3/08; G06N 3/04; G06N 3/063

(52) U.S. Cl. CPC G06N 3/084; G06N 3/063; G06N 3/04

(57) ABSTRACT

To reduce hardware idle time, accelerators implementing neural network training use pipelining where layers are fed additional training samples to process as the results of previous processing of a layer moves on to a subsequent layer. Other neural network training techniques take advantage of minibatching, where multiple training samples equal to a minibatch size are evaluated per layer of the neural network. When pipelining and minibatching are combined, the memory consumption of the training can substantially increase. Using pipelining can mean foregoing of minibatching, or choosing a small batch size, to keep the memory consumption of the training low and to retain locality of the stored training data. If pipelining is used in combination with minibatching, the training can be slow. The described embodiments, utilize virtual minibatches and virtual sub-minibatches to emulate minibatches and gain performance advantages.

### BACKGROUND

### Field of the Invention

This invention relates generally to the field of artificial intelligence processors and more particularly to artificial intelligence accelerators.

### Description of the Related Art

Recent advancements in the field of artificial intelligence (AI) has created a demand for specialized hardware devices that can handle the computational tasks associated with AI processing. An example of a hardware device that can handle AI processing tasks more efficiently is an AI accelerator. The design and implementation of AI accelerators can present trade-offs between multiple desired characteristics of these devices. For example, in some accelerators, batching of data can be used to increase some desirable system characteristics, such as hardware utilization and increased efficiency due to task and/or data parallelism offered in batched data. Batching, however, can introduce costs, such as increased memory usage.

One type of AI processing performed by AI accelerators is forward propagation and backpropagation of data through layers of a neural network. Existing hardware accelerators use batching of data during propagation to increase hardware utilization rates and implement techniques that offer efficiencies by utilizing task and/or data parallelism inherent in AI data and/or batched data. For example, multiple processor cores can be employed to perform matrix operations on discrete portions of the data in parallel. However, batching can introduce high memory usage, which can in turn reduce locality of AI data. For example, various weights associated with a neural network layer, may need to be stored in memory, so they can be updated during backpropagation. Therefore, the memory required to process a neural network through the forward and backward passes can grow as the batch size is increased. Loss of locality can slow down an AI accelerator, as the system spends more time shuttling data to various areas of the chip implementing the AI accelerator.

Techniques to exploit parallelism in processing AI workloads and to keep a high hardware utilization rate can include using pipelined backpropagation, where a layer of neural network and associated hardware can process data related to one or more input samples, while other layers in the network continue the processing of previous or subsequent input data. Using pipelining can also limit the batch size to “1” in order to keep memory consumption costs low.

As a result, systems and methods are needed to take advantage of the benefits of batching and pipelining while maintain locality of data.

### SUMMARY

In one aspect, a method of training a neural network is disclosed. The method includes: receiving a training set comprising a plurality of training samples; forward propagating and backpropagating the training samples through the neural network, wherein a forward propagation and a backpropagation of a training sample through the neural network comprises an iteration; generating gradient updates of weights and biases of the neural network, wherein each iteration yields a gradient update; updating a gradient buffer with the gradient updates after a predetermined number of training samples, comprising a virtual sub-minibatch, have forward and backpropagated through the neural network; and updating weights and biases of the neural network with the gradient buffer after a predetermined number of training samples, comprising a virtual mini batch, have forward and backpropagated through the neural network.

In one embodiment, the virtual sub-minibatch equals 1.

In another embodiment, the virtual sub-minibatch equals the virtual minibatch.

In some embodiments, the method further includes performing normalization and/or standardization on the gradient updates before updating the gradient buffer with the standardized and/or normalized gradient updates.

In some embodiments, the virtual minibatch and the virtual sub-minibatch are chosen to optimize memory usage and numerical stability of the training.

In another embodiment, forward and backpropagating comprises performing stochastic gradient descent.

In some embodiments, the method further includes, pipelining the forward and/or backpropagation, wherein pipelining comprises forward and/or backpropagating two or more training samples simultaneously through the neural network, wherein each training sample is simultaneously processed in a separate layer of the neural network.

In another embodiment, backpropagation comprises re-computation of one or more nodes of the neural network and/or gradient checkpointing.

In one embodiment, an artificial intelligence accelerator implements the method.

In one embodiment, the accelerator is configured to store forward propagation data and/or backpropagation data such that output of a layer of the neural network, during forward propagation and/or during backpropagation, are stored physically adjacent or close to a memory location where a next or adjacent layer of the neural network loads its input data.

In another aspect, an artificial intelligence accelerator is disclosed. The accelerator is configured to perform training of a neural network. The accelerator includes: one or more processor cores each having a memory module, wherein each processor core is configured to process nodes of one or more layers of a neural network, wherein a memory module associated with a processor is configured to store weights and biases of the one or more layers processed in the processor, and the one or more processors are configured to: receive a training set comprising a plurality of training samples; forward propagate and backpropagate the training samples through the neural network, wherein a forward propagation and a backpropagation of a training sample through the neural network comprises an iteration; generate gradient updates of weights and biases of the neural network, wherein each iteration yields a gradient update; update a gradient buffer with the gradient updates after a predetermined number of training samples, comprising a virtual sub-minibatch, have forward and backpropagated through the neural network; update weights and biases of the neural network with the gradient buffer after a predetermined number of training samples, comprising a virtual mini batch, have forward and backpropagated through the neural network.

In some embodiments, the virtual sub-minibatch equals 1.

In another embodiment, the virtual sub-minibatch equals the virtual minibatch.

In one embodiment, the one or more processors are configured to perform normalization and/or standardization on the gradient updates before updating the gradient buffer with the standardized and/or normalized gradient updates.

In some embodiments, the virtual minibatch and the virtual sub-minibatch are chosen to optimize memory usage and numerical stability of the training.

In one embodiment, forward and backpropagating comprises performing stochastic gradient descent.

In another embodiment, the one or more processors are further configured to pipeline the forward and/or backpropagation, wherein pipelining comprises forward and/or backpropagating two or more training samples simultaneously through the neural network, wherein each training sample is simultaneously processed in a separate layer of the neural network.

In some embodiments, backpropagation comprises re-computation of one or more nodes of the neural network and/or gradient checkpointing.

In another embodiment, the one or more processors are configured to store in the one or more memory modules forward propagation data and/or backpropagation data such that output of a layer of the neural network, during forward propagation and/or during backpropagation, are stored physically adjacent or close to a memory location where a next or adjacent layer of the neural network loads its input data.

In some embodiments, the one or more processors and the one or more memory modules comprise a three-dimensional integrated circuit.

### BRIEF DESCRIPTION OF THE DRAWINGS

These drawings and the associated description herein are provided to illustrate specific embodiments of the invention and are not intended to be limiting.

FIG. 1 illustrates a diagram of a multilayered neural network where minibatching and pipelining are used for training.

FIG. 2 illustrates a neural network where emulated batches or virtual minibatches can be used for training the neural network

FIG. 3 illustrates an example diagram of a timeline of evaluating training samples through a neural network using virtual minibatches and virtual sub-minibatches.

FIG. 4 illustrates a spatially-arranged accelerator, which can be configured to implement the embodiments described herein.

FIG. 5 illustrates an example diagram of a timeline of evaluating training samples through a neural network using virtual minibatches of size “4” and virtual sub-minibatches of size “1”.

FIG. 6 illustrates an example diagram of a timeline of evaluating training samples through a neural network using virtual minibatches and virtual sub-minibatches of the same size.

FIG. 7 illustrates a flow chart of a method of training in a neural network according to an embodiment.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

Definitions

“Image,” for example as used in “input image” can refer to any discrete data, dataset, or data structure suitable for AI processing.

“Compute utilization,” “compute utilization rate,” “hardware utilization,” and “hardware utilization rate,” can refer to the utilization rate of hardware available for processing AI models such as neural networks, deep learning or other software processing.

“Training set” can refer to a collection of known input/output pairs or input/output data structures used in training of a neural network or other AI processing such as deep learning.

“Epoch” can refer to one cycle of processing a training set forward and backward through a neural network.

Minibatching and Pipelining in Neural Network Training

Artificial intelligence (AI) techniques have recently been used to accomplish many tasks. Some AI algorithms work by initializing a model with random weights and variables and calculating an output. The model and its associated weights and variables are updated using a technique known as training. Known input/output pairs are used to adjust the model variables and weights, so the model can be applied to inputs with unknown outputs. Training involves many computational techniques to minimize error and optimize variables. One example of a model commonly used is neural networks. An example of a training method used to train neural network models is backpropagation, which is often used in training deep neural networks. Backpropagation works by calculating an error at the output and iteratively computing gradients for layers of the network backwards throughout the layers of the network. Once gradients have been calculated, a number of optimization algorithms can be used to improve the gradients. Example gradient optimizer algorithms, which can be used include, stochastic gradient descent (SGD) algorithms, momentum-based algorithms, or adaptive algorithms, such as ADAM or Nesterov Momentum algorithm. These optimization algorithms can speed up training and/or improve convergence.

Additionally, hardware can be optimized to perform AI operations more efficiently. Hardware designed with the nature of AI processing tasks in mind can achieve efficiencies that may not be available when general purpose hardware is used to perform AI processing tasks. Hardware assigned to perform AI processing tasks can also or additionally be optimized using software. An AI accelerator implemented in hardware, software or both is an example of an AI processing system which can handle AI processing tasks more efficiently.

One way in which AI processors can accelerate AI processing tasks is to take advantage of parallelism inherent in these tasks. For example, many AI computation workloads include matrix operations, which can in turn involve performing arithmetic on rows or columns of numbers in parallel. Some AI processors use multiple processor cores to perform the computation in parallel. Multicore processors can use a distributed memory system, where each processor core can have its dedicated associated memory, buffer and storage to assist it in carrying out processing. Yet another technique to improve the efficiency of AI processing tasks is to use spatially-arranged processors with distributed memories. Spatially-arranged processors can be configured to maintain desirable spatial locality in storing their processing output, relative to the subsequent processing steps. For example, operations of a neural network can involve processing input data (e.g., input images) through multiple neural network layers, where the output of each layer is the input of the next layer. Spatially-arranged processors can keep the data needed to process that layer close to the data associated with that layer by storing them in physically-close memory locations. The subsequent and associated data are stored physically nearby and so forth for each layer of the neural network.

When performing AI processing tasks, some AI processors use or are configured to use minibatching and pipelining, both to increase hardware utilization rates and to take advantage of parallelism across multiple data inputs. Minibatching can refer to inputting and processing multiple data inputs through the AI network and pipelining can refer to simultaneous processing of additional data inputs (minibatches or one data input at a time) in a neural network to keep layers (and associated hardware) partially or fully utilized.

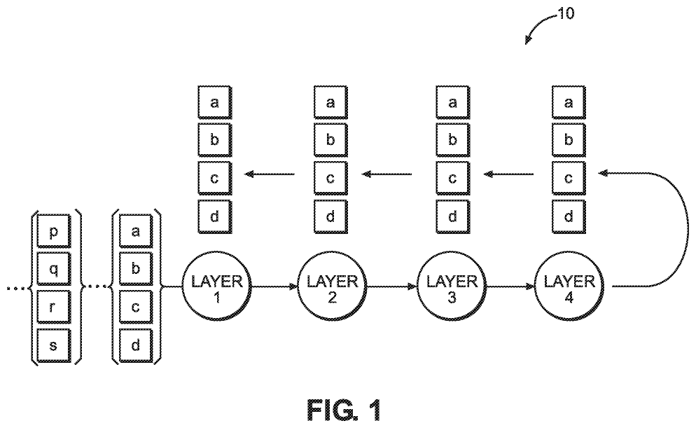

FIG. 1 illustrates a diagram of a multilayered neural network 10 where minibatching and pipelining are used for training. For illustration purposes, the neural network 10 includes four layers, but fewer or more layers are possible. Input data is batched and propagated forward through the neural network 10. For illustration purposes, each mini batch includes four input images, but fewer or more input images in each mini batch are possible. Two mini batches are illustrated, a first mini batch includes input images, a, b, c and d and a second mini batch includes input images p, q, r and s. Minibatch backpropagation (MBBP) is used to backpropagate the output of the processing of minibatches of input images backward through the layers of the neural network 10 to calculate, recalculate, and minimize one or more error functions and/or to optimize the weights, biases and variables of the neural network 10. Pipelining can be used to backpropagate a second minibatch, p, q, r, and s, while one or more previous or subsequent minibatches may be traversing back or forth in the neural network 10.

Minibatch backpropagation, similar to minibatching at input during forward propagation, can increase hardware utilization, for example when processing is performed on graphics processing units (GPUs). However, batched-backpropagation can greatly increase memory usage and, in some cases, decrease desired spatial locality in the stored data. When performing backpropagation, the processor implementing the neural network 10, in some cases, stores data associated with input images as they traverse through the network back and forth. Previous values of weights and variables are stored, recalled and used to perform backpropagation and minimize output error. As a result, some data is kept in memory until their subsequent computations no longer require them. Batching can increase memory reserved for such storage. Thus, in some cases, when batching is used, the memory consumption can be substantial, thereby negatively impacting other desirable network characteristics, such as processing times and/or spatial locality.

One technique to exploit task/data parallelism, while managing and improving memory consumption of neural network training (with or without using of minibatching techniques when processing AI workloads) is described in U.S. patent application Ser. No. 16/405,993 filed on May 7, 2019, entitled “Flexible Pipelined Backpropagation,” the content of which is hereby incorporated in its entirety and should be considered a part of this disclosure.

Some example methods that can be used to optimize the gradient updates of the weights of a neural network, can include stochastic gradient descent (SGD), batch gradient descent (BGD) and minibatch gradient descent (MBGD). Pairs of known input/output samples (also referred to as training samples) can be propagated forward and backward through a neural network and these techniques can be used to adjust the weights and biases of the neural network in a manner to decrease the error at the output of the neural network. Neural networks are trained by using training sets that can include a number of training examples or samples. SGD, BGD and MBGD can vary in the number of training samples they use and how often and when they update the weights and biases in a neural network under training. SGD calculates the output error and updates weight and bias parameters for each sample in the training set. BGD calculates the output error for each sample in the training set, but updates the model weight and bias parameters only after all training samples in the training set have been evaluated. MBGD splits the training set into small batches (e.g., 10 to 500), referred to as minibatches, and uses the minibatches to calculate the output error and update the weight and bias parameters after the training samples in each minibatch are evaluated (e.g., MBGD updates the model after each minibatch is evaluated).

SGD can be computationally demanding for applications when training is performed using large training sets taking substantially longer than other backpropagation techniques. Frequent updates in the SGD technique can also introduce noise in the gradient signal and prevent convergence in some cases. BGD on the other hand has fewer updates to the model and is computationally more efficient and less expensive to implement in hardware. Separation of calculation of prediction errors and the model updates allows the BGD to be used to exploit task/data parallelism. At the same time, applying BGD techniques can include loading an entire training set into a memory, which may not be a preferred solution to problems with large training sets. BGD techniques are less noisy, but they can be vulnerable to converging on local minima and getting stuck at local minima as opposed to converging on a global minimum.

MBGD offers a good compromise between the advantages and disadvantage offered by other training techniques. For example, the model update frequency in MBGD is higher than BGD, but not as high as SGD, allowing for some amount of noise in the gradient signal. The presence of some amount of noise in the gradient signal can help the training algorithm to “kick out” of local minima (unstuck from a local minimum) and descend toward a global minimum. On the other hand, MBGD is not as noisy as SGD, so convergence problems (e.g., bouncing around a minimum) can be less common with MBGD. Minibatch size and noise are directly proportional. A larger batch size can mean less noise in the gradient descent signal, while a smaller batch size can mean more noise in the gradient descent signal. Therefore, training can be improved by choosing an optimum batch size in order to facilitate convergence on a global minimum and avoidance of local minima.

When using pipelined backpropagation techniques often the batch size is chosen to be “1” (e.g., one training sample) in order to keep the increased memory consumption due to pipelining within reasonable bounds and maintain locality of data by storing processing data as close to where the processing data is going to be processed, for example by storing processing data of a neural network layer close to a next layer where the data can serve as input to the next layer. Therefore, typical minibatch propagation techniques become unavailable when batch size of “1” is used for pipelining of backpropagation. The described embodiments allow the advantages of MBGD to be realized by operating a model (e.g., a neural network) in a manner that emulates forward and backpropagating of minibatches, while maintaining backpropagation batch size of one or a batch size that optimizes memory usage and noise characteristics of a gradient descent signal.

Minibatches, Virtual Minibatches and Virtual Sub-Minibatches

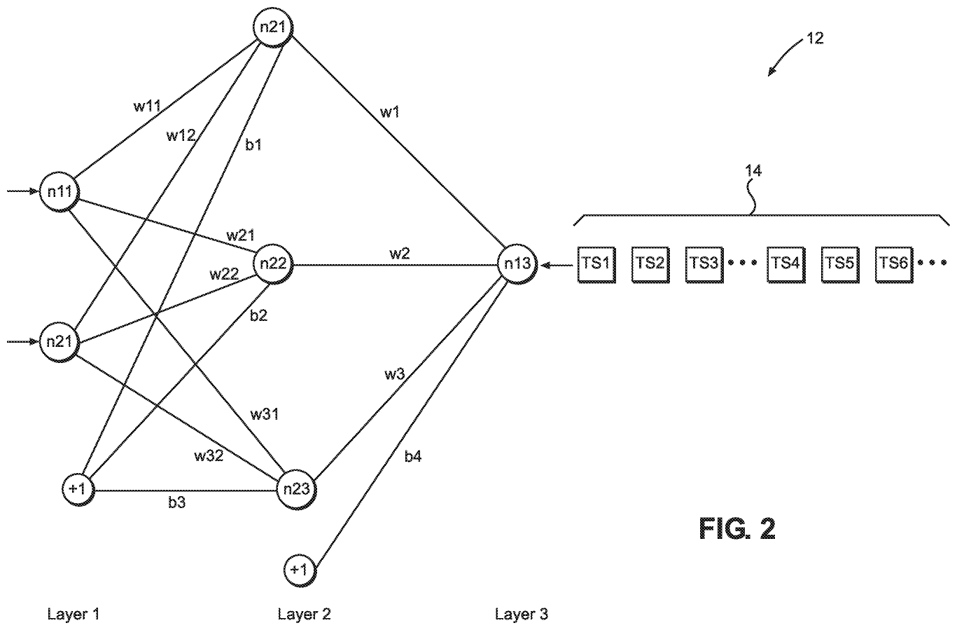

FIG. 2 illustrates a neural network 12 where emulated minibatches or virtual minibatches can be used for training the neural network. For simplicity of illustration, the neural network 12 is shown with three layers, but more layers are possible. Layer one or the input layer includes two input nodes, n11 and n21 and a+1 bias node. Layer two, or the hidden layer includes three nodes, n21, n22, n23 and a +1 bias node. Layer three includes the output node n13. The weights connecting the nodes in layer one to the nodes in layer two, as shown, include w11, w12, w21, w22, w31 and w32. Example biases in the neural network 12 include b1, b2, b3 and b4.

A training set 14 including a plurality of training examples TS1, TS2, TS3, TS4, TSS, TS6, etc. can be forward and backpropagated through the neural network 12 to update the weights and biases therein. Minibatch backpropagation includes updating the weights and biases of a neural network by averaging a cost function and finding a gradient of the cost function for input/output pairs of the minibatches. One example method of updating the weights in the neural network 12 can be described according to Equations 1 and 2, where J(W, b, x^{(z:z+bs)}, y^{(z:z+bs)}) is a cost function, W is a tensor, matrix, vector, or an N-dimensional array (ndarray) of weights in the neural network 12, b is a bias parameter in the neural network 12, a is learning rate, ∇ is gradient function, bs is minibatch size and x^{(z)}, y^{(z)} refer to an input/output pair in a training set.

$$\begin{matrix}W = W - α \cdot ∇ J ( W , b , {x}^{( z : z + b s )} , {y}^{( z : z + b s )} ) & Eq . 1 \\ J ( W , b , {x}^{( z : z + b s )} , {y}^{( z : z + b s )} ) = \frac{1}{b s} {\sum }_{z = 0}^{b s} J ( W , b , {x}^{( z )} , {y}^{( z )} ) & Eq . 2\end{matrix}$$

Various cost functions can be used, but in some embodiments a mean square root error function is used as the cost function. An example of such function is illustrated by Equation 3.

$$J ( W , b , {x}^{( z )} , {y}^{Z} ) = \frac{1}{b s} {\sum }_{z = 0}^{b s} \frac{1}{2} {‖ {y}^{( z )} - h ( {x}^{( z )} ) ‖}^{2} \qquad Eq . 3$$

When minibatch backpropagation is pipelined and more than one input/output training pair is propagated simultaneously through the neural network 12, memory usage can substantially increase, compared to SGD backpropagation, as more previous values of weights and biases for pipelined training samples are kept in memory to later update them. On the other hand, minibatch backpropagation is desirable in order to strike a balance between numerical stability of the backpropagation process and memory consumption efficiency. Furthermore, pipelining is desirable in order to increase compute utilization and reduce hardware idle time. The described embodiments allow for a virtual minibatch or an emulated minibatch, where the neural network 12 can be used to pipeline backpropagate single input/output pairs per layer while realizing the benefits of minibatch backpropagation.

In some embodiments, gradient updates (α. ∇J(W,b,x^{(z)}, y^{(z)}) for neural network 12, are added to and stored in a local gradient buffer ∇W. After a predetermined number of input/output training samples, equal to a virtual minibatch size, are evaluated, the neural network weights W are updated. By comparison, when SGD is applied, the gradient updates obtained after a training sample has cycled through the neural network 12 (one iteration), are immediately used to update the neural network 12 and its weights W and biases. By delaying the updating of a model's weights until a virtual minibatch (VMB) is evaluated, a minibatch size equal to the number of training samples in the VMB is emulated. The term “virtual” in “virtual minibatch” refers to the neural network 12 evaluating one training sample per iteration, or if pipelining is used, one training sample per layer per iteration, as opposed to minibatching, where training samples equal to the minibatch size are evaluated through the neural network per iteration or per layer if pipelining is used.

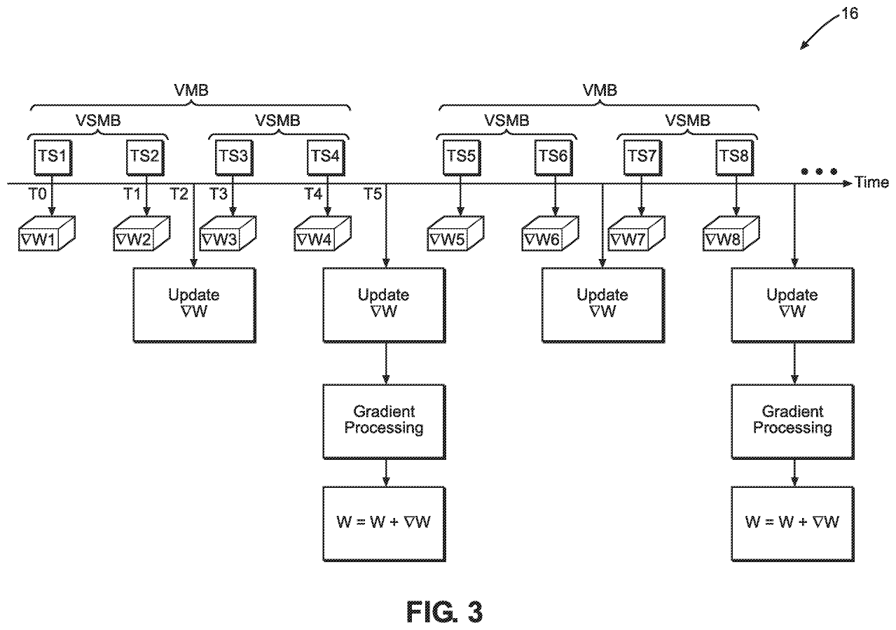

FIG. 3 illustrates an example diagram 16 of a timeline of evaluating training samples TSi (e.g., TS1, TS2, TS3, etc.) through a neural network, such as the neural network 12. The neural network 12 can be configured to process a data width, N, of size “1”, in order to keep locality of data and keep memory consumption cost low. Each training sample TSi cycles through the neural network 12 via a forward and backpropagation processing, yielding a gradient update ∇wi per iteration (e.g., ∇w1, ∇w2, ∇w3, etc.). A local gradient buffer ∇W can be used to temporarily store the gradient updates ∇wi. The frequency of updates to the local gradient buffer ∇W can be determined by the size of a virtual sub-minibatch (VSMB) M. After VSMB training samples TSi are cycled through the neural network 12, the local gradient buffer ∇W is updated. Each cycle refers to one iteration of a training sample TSi through the neural network 12, or one cycle of forward and backpropagation of a training sample TSi through the neural network 12. The training samples TSi can include a single known input/output pair used for training of the neural network 12 or they can include more complex data structures encompassing more than a pair of input/output data per training sample TSi.

In the example of diagram 16, a VMB size of four training samples TSi per VMB and two training samples TSi per VSMB are used. These VMB and VSMB sizes are used as examples and persons of ordinary skill in the art can modify these sizes according to their desired network characteristics. For example, the same considerations as discussed above in relation to SGD, BSGD and MBSGD can inform the choices of VMB and VSMB sizes here. A larger VMB increases the numerical stability of the training, while increasing memory consumption and reducing locality of data. Larger VSBM sizes can increase the efficiency of the training at the expense of memory usage. Choices of optimum VMB and VSMB sizes can depend on the nature and diversity of the training samples TSi. Persons of ordinary skill in the art can choose these variables to optimize memory usage and numerical stability of the training of the neural network 12. In some cases, the sizes of VMB and VSMB can be optimized empirically.

The term “local” in the “local gradient buffer ∇W” can refer to storing the local gradient buffer ∇W in a memory location close to (local to) where its content can be used in processing of the neural network 12. For example, in some embodiments, a local gradient ∇W can be stored per layer of the neural network and close to where its content may be used by the processing of subsequent layers of the neural network 12. In the illustrated embodiment, each VMB can be associated with a local gradient buffer ∇W stored close to it in memory location to facilitate efficient storage and loading of gradient updates ∇wi. The local gradient update ∇W can include a variety of data structures depending on the application. These can include a tensor, matrix, vector, ndarray or scalar.

In the example of diagram 16, the VMB size is four and the VSMB size is two. The local gradient buffer ∇W is updated after every two iterations, where in each iteration a training sample TSi is forward and backpropagated through the neural network 12 and a corresponding gradient update ∇wi is generated. For example, at time T0, training sample TS1 is forward and backpropagated through the neural network 12 and a corresponding gradient update ∇w1 is generated. At time T1, the training sample TS2 is forward and backpropagated through the neural network 12 and a corresponding gradient updated ∇w2 is generated. At time T2, the local gradient buffer ∇W is updated, for example, by adding ∇w1 and ∇w2 to ∇W. At time T3, the training sample TS3 is forward and backpropagated through the neural network 12 and gradient update ∇w3 is generated. At time T4, the training sample TS4 is forward and backpropagated through the neural network 12 and gradient update ∇w4 is generated. At time T5, the local gradient buffer ∇W is updated, for example, by adding ∇w3 and ∇w4 to ∇W.

In some embodiments, the gradient updates ∇wi or the local gradient buffer ∇W can undergo one or more gradient processing or preprocessing before they are added to the weights and biases of the neural network 12 and updating that network with those values. For example, standardization or normalization processing can be performed on the gradient updates ∇wi or the local gradient buffer ∇W. Standardization can include transposing the data in the gradient updates ∇wi and/or the local gradient buffer ∇W to force a standard deviation of “1” and mean of “0”. Normalization can include transposing the data to limit the range of the data in the gradient updates ∇wi and the local gradient buffer ∇W to a predetermined maximum and minimum value (e.g., [0,1], [−1,1] or other desirable ranges). Such gradient processing can minimize or reduce numerical instability in the training. In some embodiments, the gradient updates ∇wi can be grouped to performed operations which stabilize the training of neural network 12 and improve convergence probability of the neural network. These operations can include techniques known in numerical analysis literature, to prevent or reduce the probability for an out-of-bound large gradient value to force other gradient values to sum to zero, or for out-of-bound gradient values to skew averages or square error root function calculations, or for out-bound-gradient values to cause bit swamping and hurt convergence of the training of the neural network 12. In some embodiments, stochastic rounding can be used as part of gradient processing operations to counteract bit swamping and other undesirable rounding errors.

In the examples illustrated herein gradient processing is shown to be performed on the local gradient buffer ∇W after a VMB is processed. However, as described above, gradient processing or preprocessing can be performed at other times or to groups or subgroups of gradient updates at various stages. In the example diagram 16, after performing gradient processing on the local gradient buffer ∇W, the weights and biases of the neural network 12 are updated, by for example, adding the local gradient buffer ∇W to the neural network weights W (W=W+V∇W). The neural network weights W can also be any data structure including a tensor, vector, matrix, array, ndarray or similar structures. The processing of VMBs in the manner described above can continue for other training samples TSi in the training set 14, where the neural network 12 can be updated with a local gradient buffer ∇W after processing of every VMB.

In some embodiments, the described methods and devices can be combined with flexible pipelined backpropagation as described in U.S. patent application Ser. No. 16/405,993 filed on May 7, 2019, entitled “Flexible Pipelined Backpropagation,” the content of which is hereby incorporated in its entirety and should be considered a part of this disclosure. For example, data width N and/or temporal spacing M of feeding training samples TSi can be additional variables in conjunction with VMB and VSMB, which can be chosen to optimize memory usage and numerical stability of the training of the neural network 12.

Additionally, the described embodiments with or without flexible pipelined propagation can be effectively used with techniques such as activation map re-computation and gradient checkpointing to manage memory resources of re-computation or gradient checkpointing more efficiently. Without re-computation, activation maps are removed from the memory when they have finished their forward pass through the last layer of a neural network. Consequently, more activation maps accumulate at earlier layers of a neural network. Re-computation of some activation maps, however, can allow removal of those activation maps from memory sooner, but the cost associated with re-computation can be significant. Re-computation can cost quadratically in resources needed as a function of layer depth. Flexible pipelined propagation can free up more memory and alleviate some of the quadratically-costly re-computation needs in shallowest layers of a neural network. Additionally, parameters VMB and VSMB can be chosen with a view of re-computation or gradient checkpointing to free up local memory for re-computation or dedicate less memory to VMBs and VSMBs when re-computation or gradient checkpointing is used. VMB and VSMB provide additional parameters in the design of a pipelined network or flexible pipelined neural network to manage memory resources more efficiently, for example in cases where gradient checkpointing or re-computation are used.

Spatial Accelerators

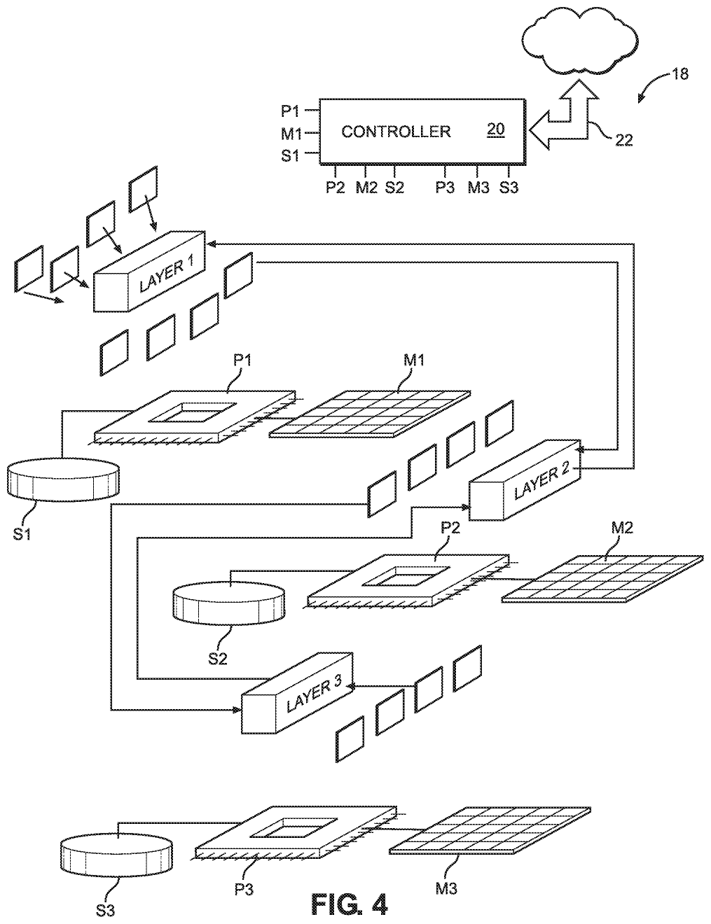

FIG. 4 illustrates a spatially-arranged accelerator 18, which can be configured to implement the neural network 12 and the embodiments described herein. The accelerator 18 can include multiple processor cores, for example P1, P2 and P3. Each processor core can be assigned to processing a layer in neural network 12. For example, P1 can be assigned to layer one, P2 can be assigned to layer two and P3 can be assigned to layer three. Processor cores P1, P2 and P3 can have dedicated memories or memory modules M1, M2 and M3, respectively. The memory modules in one embodiment can include static random-access-memory (SRAM) arrays. Processor cores can include processing hardware elements such as central processing units (CPUs), arithmetic logic units (ALUs), buses, interconnects, input/output (I/O) interfaces, wireless and/or wired communication interfaces, buffers, registers and/or other components. The processor cores P1, P2 and P3 can have access to one or more external storage, such as S1, S2 and S3, respectively. The external storage elements S1, S2 and S3 can include hard disk drive (HDD) devices, flash memory hard drive devices or other long-term memory devices.

The spatially-arranged accelerator 18 can include a controller 20, which can coordinate the operations of processor cores P1, P2, P3, memories M1, M2, M3 and external storage elements S1, S2 and S3 as well as coordinate the implementation and execution of the embodiments described herein. The controller 20 can be in communication with circuits, sensors or other input/output devices outside the accelerator 18 via communication interface 22. Controller 20 can include microprocessors, memory, wireless or wired I/O devices, buses, interconnects and other components. The controller 20 can be implemented with one or more Field Programmable Gate Arrays (FPGAs), configurable processors, central processing units (CPUs), or other similar components.

In one embodiment, the spatially-arranged accelerator 18 can be a part of a larger spatially-arranged accelerator, having multiple processors and memory devices, where the processor cores P1, P2, P3 and their associated components are used to implement the neural network 12. The spatially-arranged accelerator 18 can be configured to store activation map data in a manner to take advantage of efficiencies offered by locality of data. As shown, the pipelined formed by layers one, two and three during forward or backpropagation can be configured on processor cores P1, P2 and P3, respectively, to increase or maximize locality of activation map data. In this configuration, the output of layer one is propagated to the adjacent processor and memory next to it, the processor core P2 and memory M2. Likewise, during backpropagation, the output of layer two is backpropagated to the processor core and memory adjacent to it, the processor core P1 and memory M1. As the number of processor cores increase, assigning data to hardware in a manner that follows the forward or backward propagation path of a neural network offers efficiencies of locality. By choosing optimized parameters of flexible pipelined forward or backward propagation (data width N and temporal spacing M) and optimized parameters of pipelined propagation (VMB and VSMB), the accelerator 18 can offer an efficient hardware for processing neural networks, where desired characteristics, such as numerical stability, locality of activation map data and memory consumption efficiency are optimized.

Fewer or more processor cores are possible and the number of processor cores shown are for illustration purposes only. In one embodiment, a single processor/memory combination can be used while the controller 20 can manage the loading and storing of activation map data in a manner that maintains locality of activation map data. In one embodiment, the controller 20 and its functionality can be implemented in software, as opposed to hardware components to save on-chip area needed for accelerator 18. In other embodiments, the controller 20 and its functionality can be implemented in one or more of the processors P1, P2 and P3.

In one embodiment, the accelerator 18 can be part of an integrated system, where accelerator 18 can be manufactured as a substrate/die, a wafer-scale integrated (WSI) device, a three-dimensional (3D) integrated chip, a 3D stack of two-dimensional (2D) chips, an assembled chip which can include two or more chips electrically in communication with one another via wires, interconnects, wired and/or wireless communication links (e.g., vias, inductive links, capacitive links, etc.). Some communication links can include dimensions less than or equal to 100 micrometers (um) in at least one dimension (e.g., Embedded Multi-Die Interconnect Bridge (EMIB) of Intel® Corporation., or silicon interconnect fabric). In one embodiment, the multiple processor cores can utilize a single or distributed external storage. For example, processor cores P1, P2 and P3 can each use external storage S1.

Virtual Sub-Minibatches of Size One

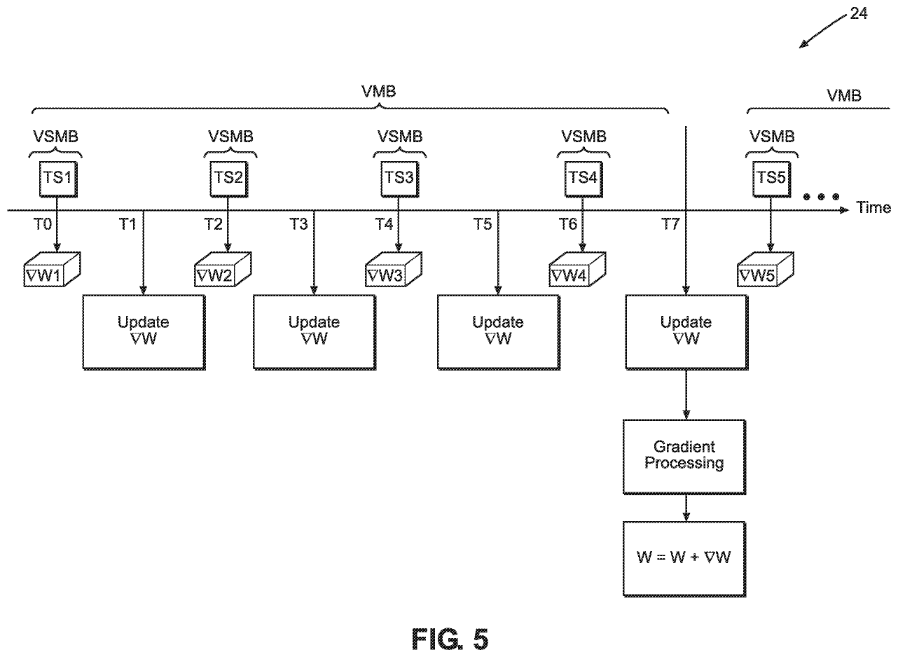

FIG. 5 illustrates a diagram 24 of a timeline of evaluating training samples TSi (e.g., TS1, TS2, TS3, etc.) through a neural network, such as the neural network 12, when a VMB size of four and a VSMB size of one is used. Similar to the example diagram 16, the neural network 12 can be configured to process a data width, N, of size “1”, in order to keep locality of data and keep memory consumption cost low. However, as described earlier, data width can be modulated to include more than one training sample cycle through the neural network 12 simultaneously per layer or per iteration. In another case, temporal spacing M in addition to or in lieu of data width N can also be modulated to further modulate the memory usage of the processing of the neural network 12. In the example of diagram 24, the local gradient buffer ∇W is updated after each iteration, where in each iteration a training sample TSi is forward and backpropagated through the neural network 12 and a corresponding gradient update ∇wi is generated.

For example, at time TO, training sample TS1 is forward and backpropagated through the neural network 12 and a corresponding gradient update ∇w1 is generated. At time T1, the local gradient buffer ∇W is updated, for example, by adding ∇w1 to ∇W. At time T2, the training sample TS2 is forward and backpropagated through the neural network 12 and a corresponding gradient updated ∇w2 is generated. At time T3, the local gradient buffer ∇W is updated, for example, by adding ∇w2 to ∇W. At time T4, the training sample TS3 is forward and backpropagated through the neural network 12 and a gradient update ∇w3 is generated. At time T5, the local gradient buffer ∇W is updated, for example, by adding ∇w3 to ∇W. At time T6, the training sample TS4 is forward and backpropagated through the neural network 12 and gradient update ∇w4 is generated. At time T7, the local gradient buffer ∇W is updated, for example, by adding ∇w4 to ∇W. Similar to the example diagram 16, gradient processing operations can be performed on the local gradient ∇W and/or one or more groups of ∇wi before the weights W of neural network 12 are updated (W=W+∇W). After time T7, the processing of one VMB and associated updating of the neural network 12 is concluded and the processing of a subsequent VMB can commence in the manner described above.

Virtual sub-minibatches equal in size to virtual minibatches

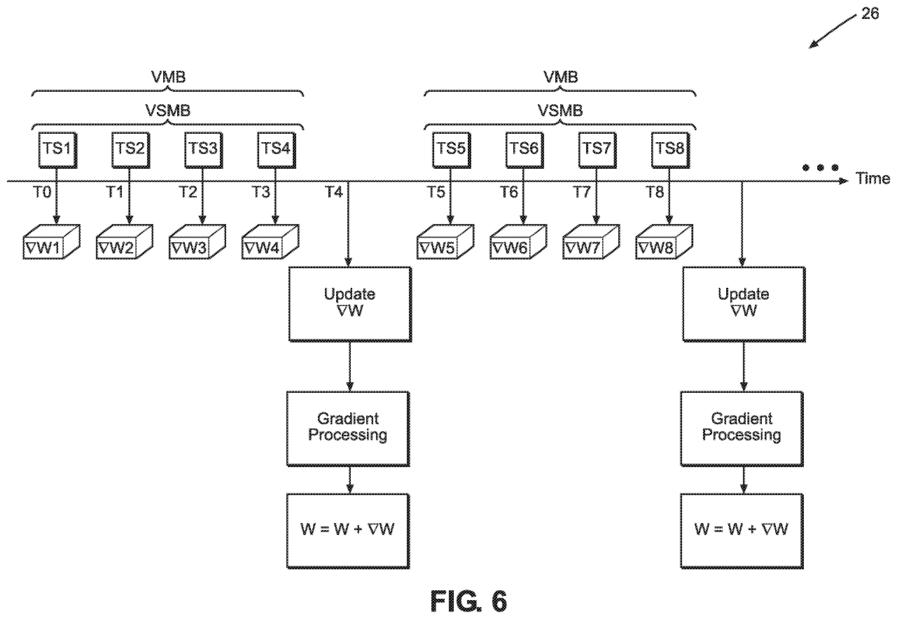

FIG. 6 illustrates a diagram 26 of a timeline of evaluating training samples TSi (e.g., TS1, TS2, TS3, etc.) through a neural network, such as the neural network 12, when VMB and VSMB of equal size (e.g., four) are used. Similar to the example diagram 16, the neural network 12 can be configured to process a data width, N, of size “1”, in order to keep locality of data and keep memory consumption cost low. However, as described earlier, data width can be modulated to include more than one training sample cycle through the neural network 12 simultaneously per layer or per iteration. In another case, temporal spacing M in addition to or in lieu of data width N can also be modulated to further modulate the memory usage of the processing of the neural network 12. In the example of diagram 26, the local gradient buffer ∇W is updated after every four iterations, where in each iteration a training sample TSi is forward and backpropagated through the neural network 12 and a corresponding gradient update ∇wi is generated.

For example, at time T0, training sample TS1 is forward and backpropagated through the neural network 12 and a corresponding gradient update ∇w1 is generated. At time T1, the training sample TS2 is forward and backpropagated through the neural network 12 and a corresponding gradient updated ∇w2 is generated. At time T2, the training sample TS3 is forward and backpropagated through the neural network 12 and a corresponding gradient updated ∇w3 is generated. At time T3, the training sample TS4 is forward and backpropagated through the neural network 12 and a corresponding gradient updated ∇w4 is generated. At time T4, the local gradient buffer ∇W is updated, for example, by adding ∇w1, ∇w2, ∇w3 and ∇w4 to ∇W. Similar to the example diagram 16, gradient processing operations can be performed on the local gradient ∇W and/or one or more groups of ∇wi before the weights W of neural network 12 are updated (W=W+∇W). After time T4, the processing of one VMB and associated updating of the neural network 12 is concluded and the processing of a subsequent VMB can commence in the manner described above.

Method of Training Neural Networks

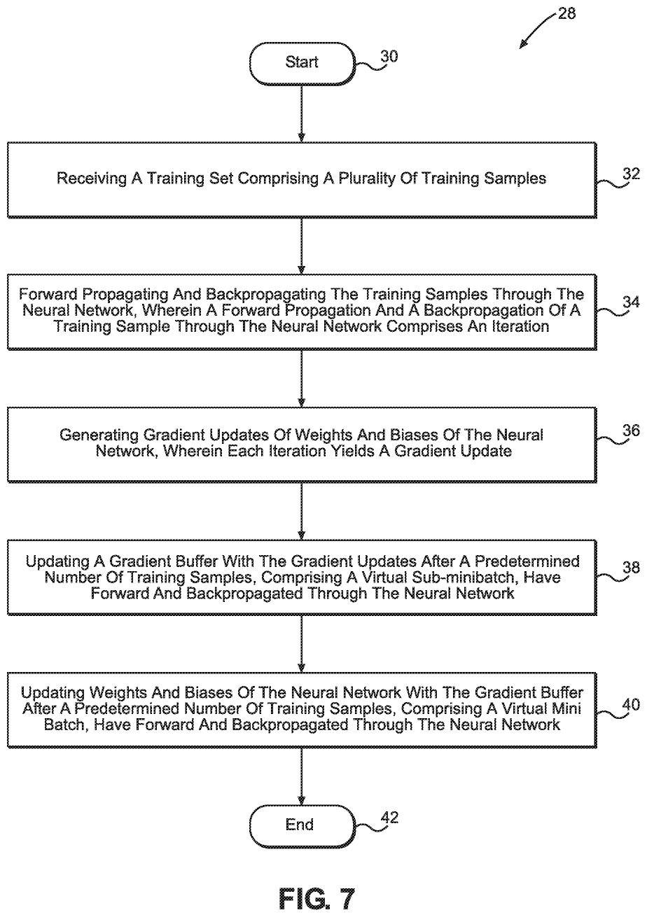

FIG. 7 illustrates a flow chart of a method 28 of training a neural network. The method 28 starts at the step 30. The method 28 moves to the step 32 by receiving a training set comprising a plurality of training samples. The method 28 moves to the step 34 by forward propagating and backpropagating the training samples through the neural network, wherein a forward propagation and a backpropagation of a training sample through the neural network comprises an iteration. The method 28 moves to the step 36 by generating gradient updates of weights and biases of the neural network, wherein each iteration yields a gradient update. The method 28 moves to the step 38 by updating a gradient buffer with the gradient updates after a predetermined number of training samples, comprising a virtual sub-minibatch, have forward and backpropagated through the neural network. The method 28 moves to the step 40 by updating weights and biases of the neural network with the gradient buffer after a predetermined number of training samples, comprising a virtual mini batch, have forward and backpropagated through the neural network. The method 28 ends at the step 42.

What is claimed is:

1. A method of training a neural network comprising:
receiving a training set comprising a plurality of training samples;
forward propagating and backpropagating the training samples through the neural network, wherein a forward propagation and a backpropagation of a training sample through the neural network comprises an iteration;
generating gradient updates of weights and biases of the neural network, wherein each iteration yields a gradient update;
updating a gradient buffer with the gradient updates after a predetermined number of training samples, comprising a virtual sub-minibatch, have forward and backpropagated through the neural network; and
updating weights and biases of the neural network with the gradient buffer after a predetermined number of training samples, comprising a virtual mini batch, have forward and backpropagated through the neural network.

2. The method of claim 1, wherein the virtual sub-minibatch equals 1.

3. The method of claim 1, wherein the virtual sub-minibatch equals the virtual minibatch.

4. The method of claim 1 further comprising performing normalization and/or standardization on the gradient updates before updating the gradient buffer with the standardized and/or normalized gradient updates.

5. The method of claim 1, wherein the virtual minibatch and the virtual sub-minibatch are chosen to optimize memory usage and numerical stability of the training.

6. The method of claim 1, wherein forward and backpropagating comprises performing stochastic gradient descent.

7. The method of claim 1, further comprising, pipelining the forward and/or backpropagation, wherein pipelining comprises forward and/or backpropagating two or more training samples simultaneously through the neural network, wherein each training sample is simultaneously processed in a separate layer of the neural network.

8. The method of claim 1, wherein backpropagation comprises re-computation of one or more nodes of the neural network and/or gradient checkpointing.

9. An artificial intelligence accelerator implementing the method of claim 1.

10. An accelerator implementing the method of claim 1, wherein the accelerator is configured to store forward propagation data and/or backpropagation data such that output of a layer of the neural network, during forward propagation and/or during backpropagation, are stored physically adjacent or close to a memory location where a next or adjacent layer of the neural network loads its input data.

11. An artificial intelligence accelerator configured to perform training of a neural network, the accelerator comprising:
one or more processor cores each having a memory module, wherein each processor core is configured to process nodes of one or more layers of a neural network, wherein a memory module associated with a processor is configured to store weights and biases of the one or more layers processed in the processor, and the one or more processors are configured to:
receive a training set comprising a plurality of training samples;
forward propagate and backpropagate the training samples through the neural network, wherein a forward propagation and a backpropagation of a training sample through the neural network comprises an iteration;
generate gradient updates of weights and biases of the neural network, wherein each iteration yields a gradient update;
update a gradient buffer with the gradient updates after a predetermined number of training samples, comprising a virtual sub-minibatch, have forward and backpropagated through the neural network;
update weights and biases of the neural network with the gradient buffer after a predetermined number of training samples, comprising a virtual mini batch, have forward and backpropagated through the neural network.

12. The accelerator of claim 11, wherein the virtual sub-minibatch equals 1.

13. The accelerator of claim 11, wherein the virtual sub-minibatch equals the virtual minibatch.

14. The accelerator of claim 11, wherein the one or more processors are configured to perform normalization and/or standardization on the gradient updates before updating the gradient buffer with the standardized and/or normalized gradient updates.

15. The accelerator of claim 11, wherein the virtual minibatch and the virtual sub-minibatch are chosen to optimize memory usage and numerical stability of the training.

16. The accelerator of claim 11, wherein forward and backpropagating comprises performing stochastic gradient descent.

17. The accelerator of claim 11, wherein the one or more processors are further configured to pipeline the forward and/or backpropagation, wherein pipelining comprises forward and/or backpropagating two or more training samples simultaneously through the neural network, wherein each training sample is simultaneously processed in a separate layer of the neural network.

18. The accelerator of claim 11, wherein backpropagation comprises re-computation of one or more nodes of the neural network and/or gradient checkpointing.

19. The accelerator of claim 11, wherein the one or more processors are configured to store in the one or more memory modules forward propagation data and/or backpropagation data such that output of a layer of the neural network, during forward propagation and/or during backpropagation, are stored physically adjacent or close to a memory location where a next or adjacent layer of the neural network loads its input data.

20. The accelerator of claim 11, wherein the one or more processors and the one or more memory modules comprise a three-dimensional integrated circuit.
